(19) United States
(12) Patent Application Publication
(10) Pub. No.: US 2016/0112347 A1
(43) Pub. Date: Apr. 21, 2016

(54) Increased Fabric Scalability by Designating Switch Types

(71) Applicant: Brocade Communications Systems, Inc., San Jose, CA (US)

(72) Inventors: Badrinath Kollu, San Jose, CA (US); Sathish Gnanasekaran, Sunnyvale, CA (US)

(21) Appl. No.: 14/517,812

(22) Filed: Oct. 18, 2014

(51) Int. Cl. H04L 12/947; H04L 12/931

(52) U.S. Cl. CPC H04L 49/25; H04L 49/205

(57) ABSTRACT

The scale of the fabric being decoupled from the scale capabilities of each switch. Only the directly attached node devices are included in the name server database of a particular switch. Only needed connections, such as those from hosts to disks, i.e., initiators to targets, are generally maintained in the routing database. When a switch is connected to the network it is configured as either a server, storage or core switch, defining the routing entries that are necessary. This configuration addresses the various change notifications that must be provided from the switch. In host to host communications, disk to tape device communications in a backup, or disk to disk communications in a data migration, there must be transfers between like type devices, i.e. between two communications devices connected to server switches or connected to storage switches. These cases are preferably developed based on the zoning information.

### BACKGROUND OF THE INVENTION

1. Field of the Invention

The present invention relates generally to storage area networks.

2. Description of the Related Art

Storage area networks (SANs) are becoming extremely large. Some of the drivers behind this increase in size include server virtualization and mobility. With the advent of virtualized machines (VMs), the number of connected virtual host devices has increased dramatically, to the point of reaching scaling limits of the SAN. In a Fibre Channel fabric one factor in limiting the scale of the fabric is the least capable or powerful switch in the fabric. This is because of the distributed services that exist in a Fibre Channel network, such as the name server, zoning and routing capabilities. In a Fibre Channel network each switch knows all of the connected node devices and computes routes between all of the node devices. Because of the information maintained in the name server for each of the node devices and the time required to compute the very large routing database, in many cases a small or less powerful switch limits the size of the fabric. It would be desirable to alleviate many of the conditions that cause this smallest or least powerful switch to be a limiting factor to allow larger fabrics to be developed.

### SUMMARY OF THE INVENTION

In a Fibre Channel fabric and its included switches according to the present invention, the scale of the fabric has been decoupled from the scale capabilities of each switch. A first change is that only the directly attached node devices are included in the name server database of a particular switch. A second change that is made is that only needed connections, such as those from hosts to disks, i.e., initiators to targets, are generally maintained in the routing database. To assist in this development of limited routes, when a switch is initially connected to the network it is configured as either a server switch, a storage switch or a core switch, as this affects the routing entries that are necessary. This configuration further addresses the various change notifications that must be provided from the switch. For example, a server switch only provides local device state updates to storage switches that are connected to a zoned, online storage device. A storage switch, however, provides local device state updates to all server switches as a means of keeping the server switches aware of the presence of the storage devices.

In certain cases, such as host to host communications, such as a vMotion or transfer of a virtual machine between servers, disk to tape device communications in a backup, or disk to disk communications in a data migration, there must be transfers between like type devices, i.e. between two communications devices connected to server switches or connected to storage switches. These cases are preferably developed based on the zoning information.

By reducing the number of name server entries and the number of routing entries, the capabilities of each particular switch are dissociated from the scale of the fabric and the number of attached nodes. The scalability limits now are more directly addressed on a per server switch or per storage switch limit rather than a fabric limit. This in turn allows greater scalability of the fabric as a whole by increasing the scalability of the individual switches and allowing the fabric scale to be based on the sum of the switch limits rather than the limits of the weakest or least capable switch.

### BRIEF DESCRIPTION OF THE DRAWINGS

The present invention has other advantages and features which will be more readily apparent from the following detailed description of the invention and the appended claims, when taken in conjunction with the accompanying drawings, in which:

FIG. 1 illustrates an exemplary fabric according to both the prior art and the present invention.

FIG. 2 illustrates the name server and route entries for the switches of FIG. 1 according to the prior art.

FIG. 3 illustrates the name server and route entries for the switches of FIG. 1 according to the present invention.

FIG. 4 illustrates a second embodiment of an exemplary fabric which includes a core switch according to the present invention.

FIG. 5 illustrates the name server and route entries for the switches of FIG. 4 according to the present invention.

FIG. 6 illustrates a third embodiment of an exemplary fabric which includes a tape device according to the present invention.

FIG. 7 illustrates the name server and route entries for the switches of FIG. 6 according to a first alternate embodiment of the present invention.

FIG. 8 illustrates the name server and route entries for the switches of FIG. 6 according to a second alternate embodiment of the present invention.

FIG. 9 is a flowchart of switch operation, according to the present invention.

FIG. 10 is a block diagram of an exemplary switch according to the present invention.

### DETAILED DESCRIPTION

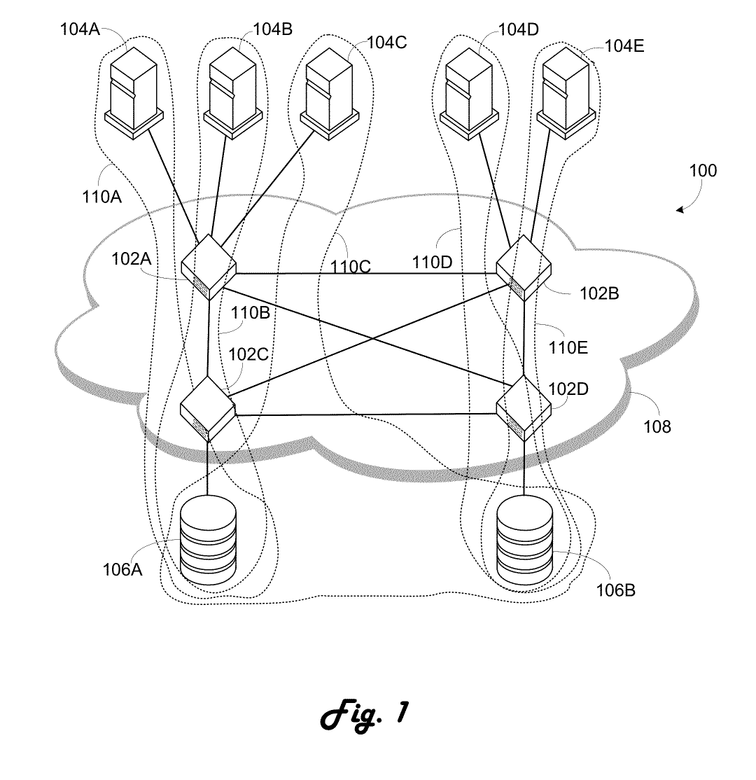

Referring now to FIG. 1, an exemplary network 100 is illustrated. This network 100 is used to illustrate both the prior art and an embodiment according to the present invention. Four switches 102A, 102B, 102C and 102D form the exemplary fabric 108 and are fully cross connected. Preferably the switches are Fibre Channel switches. Each of the switches 102A-D is a domain, so the domains are domains A-D. Three servers or hosts 104A, 104B, 104C are node devices connected to switch 102A. Two hosts 104D and 104E are the node devices connected to switch 102B. A storage device 106A is the node device connected to switch 102C and a storage device 106B is the node device connected to switch 102D.

Also shown on FIG. 1 are the various zones in this embodiment. A first zone 110A connects host or server 104A and storage device or target 106A. A second zone 110B includes server 104B and target 106A. A third zone 110C includes server 104C and targets 106A and 106B. This zone is provided for illustration as conventionally only one storage device and one server is included in a zone, so that zone 110C would conventionally be two zones, one for each storage device. A fourth zone 110D includes host 104D and target 106B. A fifth zone 110E includes host 104E and target 106B.

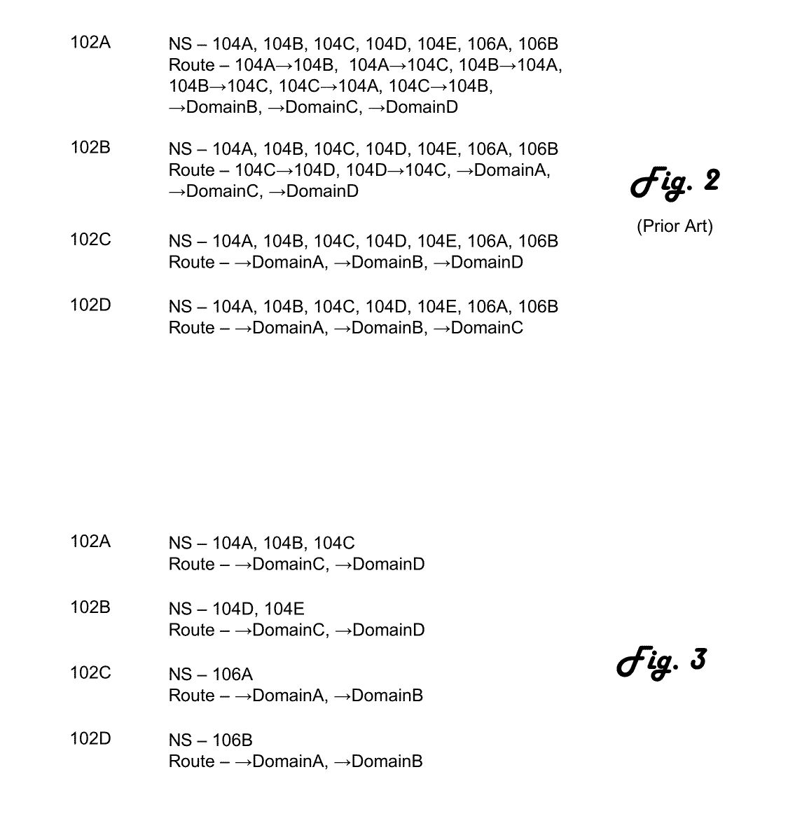

Referring to FIG. 2, the name server and route table entries for each of the switches 102A-D according to the prior art is shown. Taking switch 102A as exemplary, the name server database includes entries for the four hosts 104A-E and the two targets 106A, B. FIG. 2 only shows the particular devices, not the entire contents of the name server database for each entry, the typical contents being well known to those skilled in the art. The route table include entries between all of the hosts 104A-C connected to the switch 102A and to each of domains B-D of the other switches 102B-D. The entries in the remaining switches 102B-D are similar except that the route table entries in switches 102C and 102D do not include any device to device entries as only a single device is connected in the present example. It is understood that the present example is very simple for the purposes of illustration and in conventional embodiments there would be many hosts or servers connected to a single switch, with each server often containing many virtual machines, and many targets connected to a single switch, with the fabric having many more than the illustrated four switches. It is this larger number that creates the problems to be solved but the use of a simple example is considered to be sufficient to teach one skilled in the art, that person skilled in the art understanding the scale improvements that result.

As can be seen from these simplistic entries, each switch includes many different name server entries, one for each attached node device, even though the vast majority of the nodes are not connected to that particular switch. Similarly, in route table entries there are numerous route entries for paths that will never be utilized, such as for switch 102A the various entries between the various hosts 104A-C.

In normal operation in a conventional SAN, hosts or servers only communicate with disks or targets and do not communicate with other servers or hosts. Therefore the inclusion of all of those server to server entries in the route database and the time taken to compute those entries is unnecessary and thus burdensome to the processor in the switch. Similarly, all of the unneeded name server database entries and their upkeep is burdensome on the switch processor.

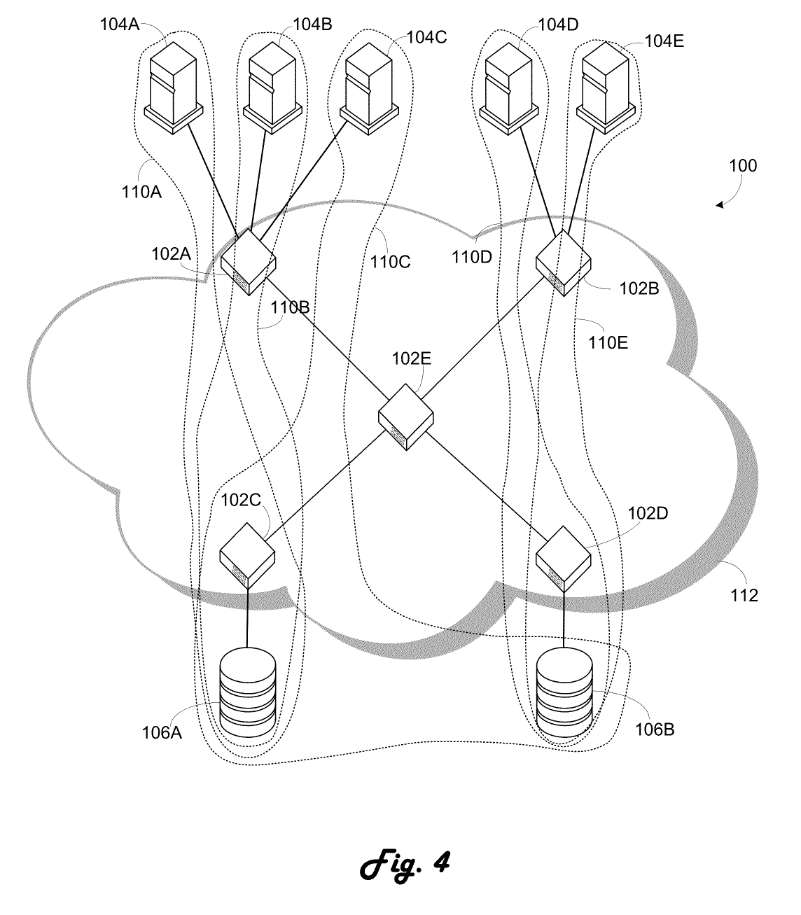

Referring now to FIG. 3, name server database and route table entries according to the present invention are illustrated. In switches according to the present invention the name server database only contains entries for the locally connected devices and the route table only contains domain entries between server switches and storage switches where a storage device is zoned with a host or server connected to the server switch. For example, for switch 102A the name server database only includes entries for the hosts 104A-C. The route table only includes entries for routing packets to domains C and D as those are the two domains of switches 102C and 102D, the switches which are connected to storage devices 106A, B. As the exemplary zone 110C includes both storage devices 106A and 106B, both domains C and D are necessary to be routed to from switch 102A. If zone 110C only included storage device 106A, then an entry for domain D would not be required and could be omitted from the route table.

Device state updates, using SW_RSCNs (switch registered state change notifications) for example, are sent only from server switches to storage switches, such as switches 102C and D, with zoned, online storage devices. If a connected node device such as host 104A queries the switch 102A for node devices not connected to the switch 102A, then switch 102A can query the other switches 102B-D in the fabric 108 as described in U.S. Pat. No. 7,474,152, entitled “Caching Remote Switch Information in a Fibre Channel Switch,” which is hereby incorporated by reference. Operation of storage switches 102C and 102D is slightly different in that each of the storage switches must have route entries to each of the other switches, i.e. the other domains, to allow for delivery of change notifications to the server switches 102A and 102B. This is the case even if there are no servers zoned into or online with any storage devices connected to the storage switch.

As can be seen, the name server and routing tables according to the present invention are significantly smaller and therefore take significantly less time to maintain and develop as compared to the name server and route tables according to the prior art. By reducing the size and maintenance overhead significantly, more devices can be added to the fabric 108 and thus using particular switches will scale to a much larger number, given that the switch processor capabilities are one of the limiting factors because of the number of name server and route table entries that need to be maintained. This allows the fabric to scale to much larger levels for a given set of switches or switch processor capabilities than otherwise would have been capable according to the prior art.

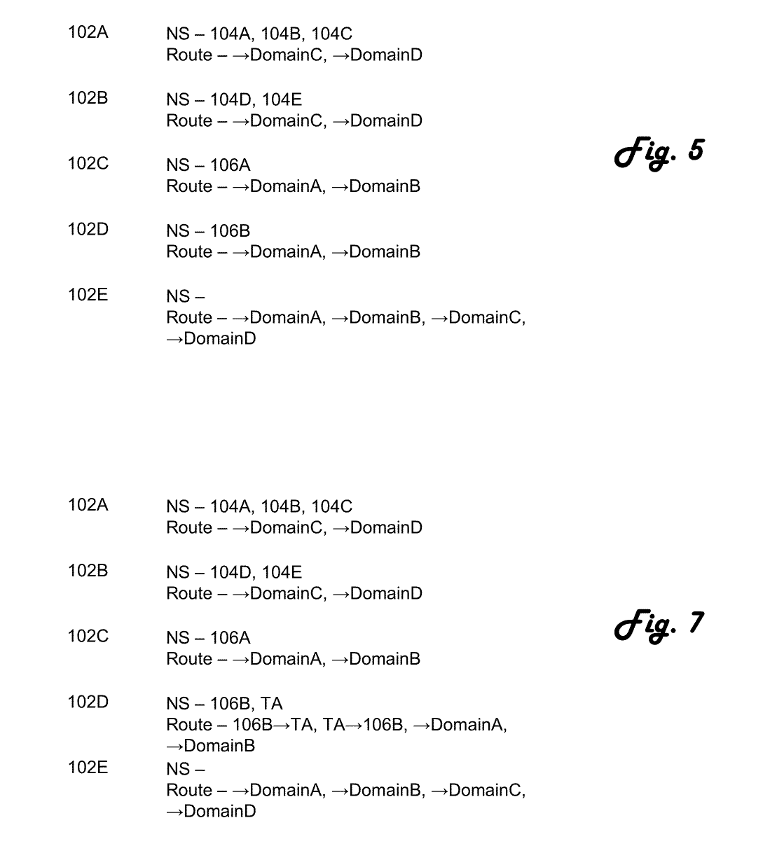

Referring now to FIG. 4 a second fabric 112 is illustrated. This fabric 112 is similar to the fabric 108 except that instead of the switches 102A-D being cross connected, each of the switches 102A-D are now directly connected to a core switch 102E. FIG. 5 illustrates the name server and route table entries for the embodiment of FIG. 4 according to the present invention. As can be seen, the name server and route table entries for switches 102A-D have not changed. The switch 102E, the core switch, has no node server entries as no node devices are directly connected to switch 102E. The route table entries include all four domains as packets must be routed to all of the domains in the fabric 112. As this core switch being connected to each edge switch is a typical topology, these name server core and routing tables would be a typical configuration of the name server and route tables in conventional use, though, as discussed above, in practice there would be many more entries in such table.

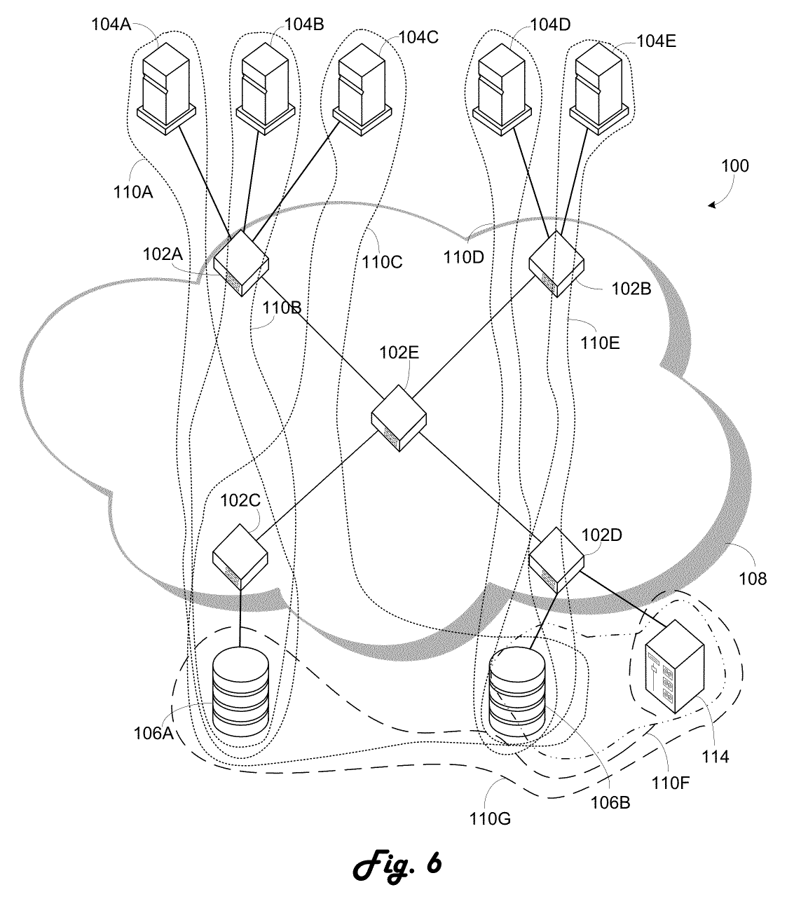

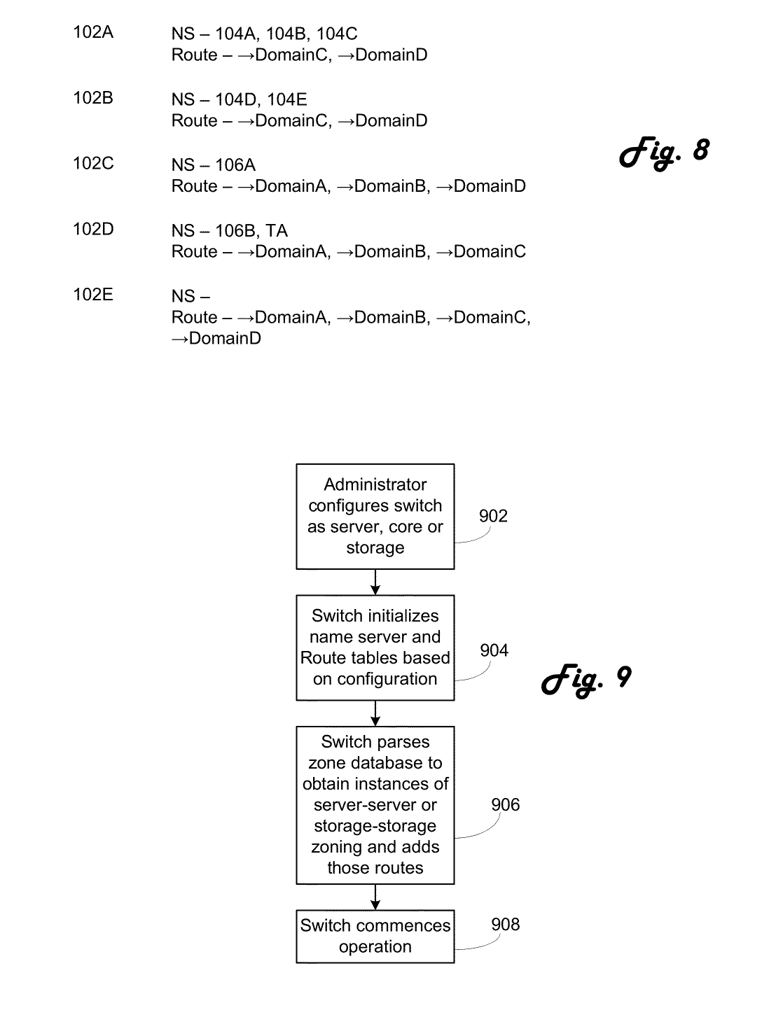

As discussed above, there are certain instances where hosts must communicate with each other and/or storage devices must communicate with each other. The illustrated example of FIG. 6 has a tape device 114 connected to switch 102D. The tape device 114 is a backup device so that data is transferred from the relevant storage device 106A, B to the tape device 114 for backup purposes. Another case of communication between storage devices is data migration. In the first alternative of FIG. 6 a zone 110F is developed which includes the storage unit 106B and the tape drive 114. FIG. 7 illustrates the name server and route table entries for such a configuration. For switch 102D the name server includes two entries, the storage unit 106 and the tape drive 114. The route table of switch 102D has resulting route table entries between the two devices as well as domains A and B. If zone 110F is not utilized, but zone 110G is utilized, which includes tape drive 114 and storage unit 106A, then FIG. 8 illustrates the name server and route table entries. As can be seen, for switch 102C, the route table has an additional entry to domain D while switch 102D has an additional entry for routing to domain C.

Virtual machine movement using mechanisms such as vMotion can similarly result in communicators between servers. Similar to the above backup operations, the two relevant servers would be zoned together and the resulting routing table entries would be developed.

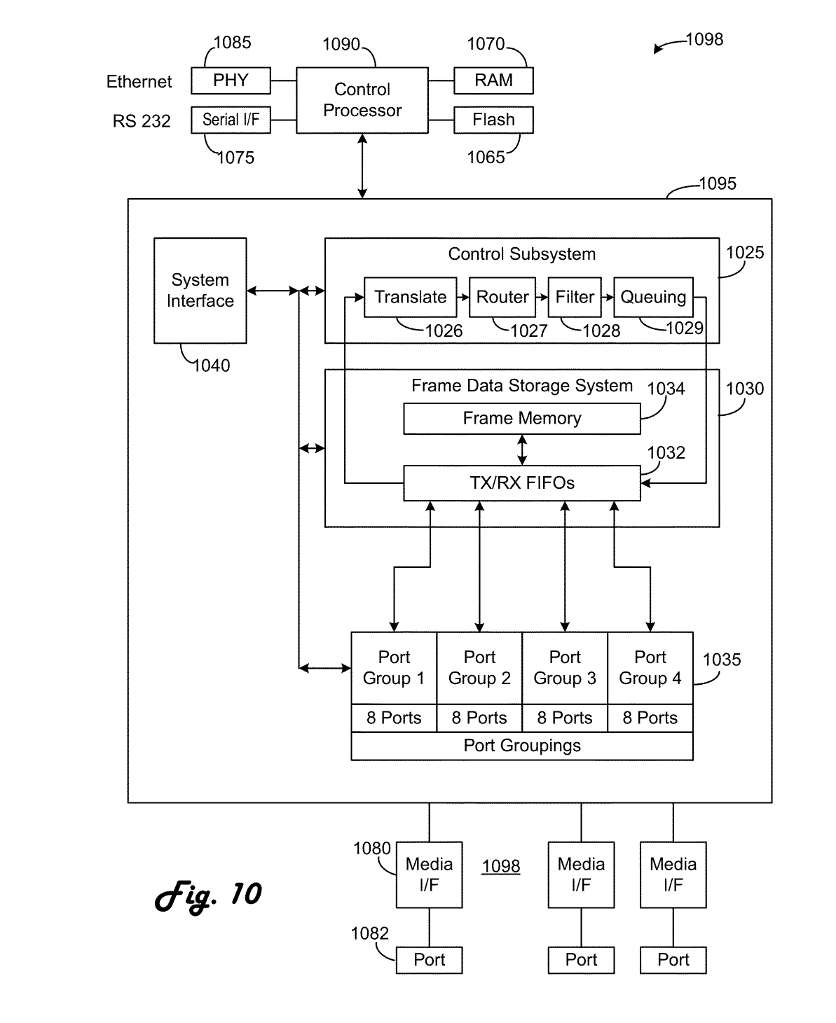

In the preferred embodiment the name server entries and route table entries develop automatically for the server and storage designated switches. Referring to FIG. 9, during initial setup of a switch an administrator configures the switch as server, core or storage based on connected node devices or node devices to be connected to the switch, as shown in step 902. When a server switch is initialized, it automatically only initializes the name server for the locally attached devices and routing table entries only for zoned in target devices as shown in step 904. Similarly for storage switches, upon their initialization the name server only includes entries for the locally attached target devices but the route table includes entries for all domains which include server switches. As discussed, this allows a storage switch to forward device change notifications to all server switches so that the existence and presence of the storage switch, and thus storage devices, is known even if none of the presently attached servers or hosts are currently zoned into such a target device. A core switch upon its initialization will also have no name server entries and will automatically populate the routing table as illustrated.

Developing the non-standard routes and instances, such as the illustrated tape device backup configurations or vMotion instances, is preferably done on an exception basis by a particular switch parsing zone database entries as shown in step 906 to determine if there are any devices included in the zone which have this horizontal or other than storage to server routing. If such a zone database entry is indicated, such as zones 110F or 110G, then the relevant switches include the needed routing table entries. Alternatives to zone database parsing can be used, such as FCP probing; WWN decoding, based on vender decoding and then device type; and device registration. After the parsing, the switch commences operation as shown in step 908.

Table 1 illustrates various parameters and quantities according to the prior art and according to the present invention to provide quantitative illustration of the increase in possible network size according to the present invention.

TABLE 1

| | | Preferred |
|---|---|---|
| | Prior Art | Embodiments |
| Server devices per switch | 4k | 4k |
| Server devices per fabric | 5333 | 16k (4 switches) |
| Server-to-Storage provisioning | 8 to 1 | 8 to 1 |
| Storage devices per switch | 512 | 512 |
| Storage devices per fabric | 667 | 2k (4 switches) |
| Devices seen by Server Switch | 6k | 6k |
| Devices seen by Storage Switch | 6k | 4.5k |
| Maximum devices in fabric | 6k | 18k (16k + 2k) |
| Name Server database size on Server | 6k | 6k |
| switch | | |
| Name Server database size on Storage | 6k | 4.5k |
| switch | | |
| Zones programmed on Server switch | 32K | 4k |
| Zones programmed on Storage switch | 4k | 4k |
| Unused Routes programmed on Server | 27k | o |
| Switch | | |
| Unused Routes programmed on Storage | 27k | o |
| Switch | | |

The comparison is done using scalability limits for both approaches for current typical switches. A server switch sees local devices and devices on all storage switches while a storage switch sees local devices and only servers zoned with local devices. For the comparison there are four server switches and four storage switches, with the server switches all directly connected to each of the storage switches. Another underlying assumption is that each switch has a maximum of 6000 name server entries.

Reviewing then Table 1, it is assumed that there are a maximum of 4000 server devices per switch. This number can be readily obtained using virtual machines on each physical server or using pass through or Access Gateway switches. Another assumption is that there are eight server devices per storage device. This is based on typical historical information. Yet another assumption is that there is a maximum of 512 storage devices per switch. With these assumptions this results in 5333 server devices per fabric according to the prior art. This number is developed because of the 6000 device limit for the name server in combination with the eight to one server to storage ratio. This then results in 667 storage devices per fabric according to the prior art. As can be seen, these numbers 5333 and 667 are not significantly greater than the maximum number per individual switch, which indicates the scalability concerns of the prior art. According to the preferred embodiment there can be 16,000 server devices per fabric, assuming the four server switches. This is because there can be 4000 server devices per switch and four switches. The number of storage devices per fabric will be 2000, again based on the four storage switches. The number of devices seen by the server switch or storage switch in the prior art was 6000. Again this is the maximum number of devices in the fabric based on the name server database sizes. In the preferred embodiment each server switch still sees 6000 devices but that is 4000 devices for the particular server switch and the 2000 storage devices per fabric as it is assumed that each server switch will see each storage device.

As the servers will be different for each server switch, the 4000 servers per switch will be additive, resulting in the 16,000 servers in the fabric. As the name server can handle 6000 entries, this leaves space for 2000 storage units, 500 for each storage switch. The number of devices actually seen by a storage switch is smaller as it only sees the local storage devices, such as the 512, and server devices which are zoned into the local storage devices. For purposes of illustration it is assumed to be 4500 devices seen per storage switch in the preferred embodiments. While in the prior art there was a maximum of 6000 devices in the entire fabric, according to preferred embodiment that maximum is 18,000 devices, which is developed by the 16,000 devices for the four server switches and the 2000 devices for the four storage switches.

In the prior art 32,000 zones would be programmed into a server switch and 4000 into storage switch based on the assumption of one zone for each storage device. In the preferred embodiments there would be 4000 zones on each switch. According to the prior art there are 27,000 unused routes programmed into either a server or storage switch while in the preferred embodiment there are no unused routes. As can be seen from the review of Table 1, significantly more server and storage devices can be present in a particular fabric when the improvements of the preferred embodiments according to the present invention are employed.

FIG. 10 is a block diagram of an exemplary switch 1098. A control processor 1090 is connected to a switch ASIC 1095. The switch ASIC 1095 is connected to media interfaces 1080 which are connected to ports 1082. Generally the control processor 1090 configures the switch ASIC 1095 and handles higher level switch 1007 operations, such as the name server, routing table setup, and the like. The switch ASIC 1095 handles general high speed inline or in-band operations, such as switching, routing and frame translation. The control processor 1090 is connected to flash memory 1065 or the like to hold the software and programs for the higher level switch operations and initialization such as performed in steps 904 and 906; to random access memory (RAM) 1070 for working memory, such as the name server and route tables; and to an Ethernet PHY 1085 and serial interface 1075 for out-of-band management.

The switch ASIC 1095 has four basic modules, port groups 1035, a frame data storage system 1030, a control subsystem 1025 and a system interface 1040. The port groups 1035 perform the lowest level of packet transmission and reception. Generally, frames are received from a media interface 1080 and provided to the frame data storage system 1030. Further, frames are received from the frame data storage system 1030 and provided to the media interface 1080 for transmission out of port 1082. The frame data storage system 1030 includes a set of transmit/receive FIFOs 1032, which interface with the port groups 1035, and a frame memory 1034, which stores the received frames and frames to be transmitted. The frame data storage system 1030 provides initial portions of each frame, typically the frame header and a payload header for FCP frames, to the control subsystem 1025. The control subsystem 1025 has the translate 1026, router 1027, filter 1028 and queuing 1029 blocks. The translate block 1026 examines the frame header and performs any necessary address translations, such as those that happen when a frame is redirected as described herein. There can be various embodiments of the translation block 1026, with examples of translation operation provided in U.S. Pat. No. 7,752,361 and U.S. Pat. No. 7,120,728, both of which are incorporated herein by reference in their entirety. Those examples also provide examples of the control/data path splitting of operations. The router block 1027 examines the frame header and selects the desired output port for the frame. The filter block 1028 examines the frame header, and the payload header in some cases, to determine if the frame should be transmitted. In the preferred embodiment of the present invention, hard zoning is accomplished using the filter block 1028. The queuing block 1029 schedules the frames for transmission based on various factors including quality of service, priority and the like.

Therefore by designating the switches as server, storage or core switches; eliminating routes that are not between servers and storage, except on an exception basis; and only maintaining locally connected devices in the name server database, the processing demands on a particular switch are significantly reduced. As the processing demands are significantly reduced, this allows increased size for the fabric for any given set of switches or switch performance capabilities.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A switch comprising:
a processor;
random access memory coupled to said processor;
program storage coupled to said processor; and
at least two ports coupled to said processor, at least one port for connecting to a node device and at least one port for connecting to another switch,
wherein said program storage includes a program which, when executed by said processor, causes said processor to perform the following method:
receiving a designation of the switch as one switch type of a plurality of switch types based on node devices connected or to be connected to the switch;
developing name server entries for only node devices connected to the switch; and
developing routes based on switch type and only between server and storage devices as a default condition.

2. The switch of claim 1, wherein said plurality of switch types include server and storage.

3. The switch of claim 2, wherein said plurality of switch types further include core.

4. The switch of claim 1, the method further comprising:
developing routes between servers and between storage devices on an exception basis.

5. The switch of claim 4, wherein said developing routes between servers and between storage devices is performed based on review of zoning entries.

6. A method comprising:
receiving a designation of a switch as one switch type of a plurality of switch types based on node devices connected or to be connected to said switch;
developing name server entries for only node devices connected to said switch; and
developing routes based on switch type and only between server and storage devices as a default condition.

7. The method of claim 6, wherein said plurality of switch types include server and storage.

8. The method of claim 7, wherein said plurality of switch types further include core.

9. The method of claim 6, further comprising:
developing routes between servers and between storage devices on an exception basis.

10. The method of claim 9, wherein said developing routes between servers and between storage devices is performed based on review of zoning entries.

11. A non-transitory computer readable medium comprising instructions stored thereon that when executed by a processor cause the processor to perform a method, the method comprising:
receiving a designation of a switch as one switch type of a plurality of switch types based on node devices connected or to be connected to said switch;
developing name server entries for only node devices connected to said switch; and
developing routes based on switch type and only between server and storage devices as a default condition.

12. The non-transitory computer readable medium of claim 11, wherein said plurality of switch types include server and storage.

13. The non-transitory computer readable medium of claim 12, wherein said plurality of switch types further include core.

14. The non-transitory computer readable medium of claim 11, the method further comprising:
developing routes between servers and between storage devices on an exception basis.

15. The non-transitory computer readable medium of claim 14, wherein said developing routes between servers and between storage devices is performed based on review of zoning entries.
